(19) United States
(12) Patent Application Publication
(10) Pub. No.: US 2005/0135641 A1
(43) Pub. Date: Jun. 23, 2005

(54) Variable directional capacitor microphone comprising elastic acoustic resisting member

(75) Inventor: Hiroshi Akino, Sagamihara-shi (JP)

Correspondence Address: WELSH & KATZ, LTD, 120 S RIVERSIDE PLAZA, 22ND FLOOR, CHICAGO, IL, 60606, US

(73) Assignee: Kabushiki Kaisha Audio-Technica, Tokyo (JP)

(21) Appl. No.: 11/016,941

(22) Filed: Nov. 30, 2004

(30) Foreign Application Priority Data
Dec. 18, 2003 (JP) 2003-421046

(51) Int. Cl. H04R 11/04; H04R 25/00

(52) U.S. Cl. 381/174; 381/170; 381/356

(57) ABSTRACT

It is an object of the present invention to provide a variable directional capacitor microphone in which two capacitor elements are combined. Each of the capacitor elements includes a vibrating plate and a fixed electrode, and an acoustic resistance can be adjusted in the state that the microphone has been assembled.

As shown in FIG. 2, a variable directional capacitor microphone of this invention includes capacitor elements 10a, 10b. In each of the capacitor elements 10a, 10b, each of vibrating plate supporting members 12a, 12b, each of spacer rings 13a, 13b, each of fixed electrodes 14a, 14b having through holes 141 and each of insulating pedestals 15a, 15b having a through hole in each center of the pedestals are integratedly assembled in this order, respectively, in each of ring-shape cases 16a, 16b. Each of vibrating plates 11a, 11b is strained and fixed on each of vibrating plate supporting members 12a, 12b, respectively. The capacitor elements 10a, 10b are combined through a connecting ring 22 having female screw threads 221 with the insulating pedestal 15a, 15b facing back-to-back. An elastic acoustic resisting member 31 is disposed between the insulating pedestals 15a, 15b. The acoustic resistance of the acoustic resisting member 31 can be adjusted with the lengths of thread engagement of the insulating pedestals 15a, 15b with the connecting ring 22.

### FIELD OF THE INVENTION

The present invention relates to a variable directional microphone. More particularly, the invention relates to the variable directional microphone having two capacitor elements each of which includes a vibrating plate and a fixed electrode with the both capacitor elements combined in the microphone.

### BACKGROUND OF THE INVENTION

Japanese Patent registration No. 3299829 discloses a variable directional capacitor microphone including two capacitor elements each of which has a vibrating plate and a fixed electrode. The two capacitor elements are combined as to supply a part of sound pressure impressed to a vibrating plate of the one capacitor element (a rear capacitor element) to the back side of a vibrating plate of the other capacitor element (a front capacitor element). The structure will be described referring to FIGS. 3 and 4. FIG. 3 is a cross sectional view of the variable directional capacitor microphone which has been assembled and FIG. 4 is an exploded cross sectional view of that of FIG. 3.

The variable directional capacitor microphone includes a first and a second capacitor elements 10a, 10b. Each of the capacitor elements has the same structure so that the first capacitor element 10a will be explained hereinafter. Constitutional elements corresponding to the second capacitor element 10b are attached with the same reference numerals as that of constitutional elements corresponding to the first capacitor element, together with a reference symbol “b”.

The capacitor element 10a has a case 16a which is formed in a ring shape with electric insulating material. A vibrating plate supporting member 12a, a spacer ring 13a, a fixed electrode 14a and an insulating pedestal 15a are assembled in the case 16a in this order. A vibrating plate 11a is fixed and strained with a predetermined tension force on the vibrating plate supporting member 12a.

The case 16a has an inner edge flange 161 latched with the circumference of the vibrating plate supporting member 12a and female screw threads 162 formed on an inner surface of a body of the case. The outer circumference of the insulating pedestal 15a has male screw threads 151 screwed with the female screw threads 162. Therefore, the insulating pedestal 15a is screwed to the case 16a so that the vibrating plate 11a and the fixed electrode 14a are faced together and are securely fixed through the spacer ring 13a.

An electrode rod 121 is extracted from the vibrating plate supporting member 12a. FIG. 3 or 4 illustrates only one through hole 141, however, the fixed electrode 14a has a number of through holes 141. The insulating pedestal 15a is formed in a saucer-shape with the circumference of the insulating pedestal 15a protruding such that an air chamber having a predetermined air volume is formed between the insulating pedestal 15a and the fixed electrode 14a. The center of the bottom of the fixed electrode 15a has a through hole 152. The both sides of the through hole 152 are covered with two sheets of acoustic resisting members 17a and 18b formed with nylon mesh or the like.

The first and the second capacitor elements 10a and 10b are combined through a connecting ring 22 having female screw threads 221 in the state that the insulating pedestals 15a and 15b are faced back-to-back and a gasket 21 formed in a ring shape is disposed between the both pedestals.

Male screw threads 151 of the insulating pedestal 15a are screwed from one side of the connecting ring 22 and on the other hand, the male screw threads 151 of the insulating pedestal 15b are screwed from the other side of the connecting ring 22. Then the first and the second capacitor elements 10a and 10b are combined with each other through the connecting ring 22.

A first air chamber A1 is formed in the space between the fixed electrode 14a and the insulating pedestal 15a of the first capacitor element 10a, a second air chamber A2 formed in the space between acoustic resisting members 17a and 17b, a third air chamber A3 formed in the space of the center porting of the gasket with the both sides of the space surrounded by the insulating pedestals 15a and 15b, a fourth air chamber A4 formed between the acoustic resisting members 17b and 18b of the second capacitor element 10b, a fifth air chamber A5 formed between the fixed electrode 14b and the insulating pedestal 15b. The back sides of the vibrating plates 14a and 14b acoustically communicate through the acoustic capacities connecting in a ladder-form of the five air chambers A1 to A5.

According to the prior art of the structure described above, each of the first and the second capacitor elements 10a and 10b can be operated respectively before the both elements are combined so that a pair of capacitor elements having similar technical performances are selected and combined to obtain a microphone having wholly stable characteristics.

The variable directional capacitor microphone of the prior art described above is required that the output of each of the capacitor elements 10a, 10b has a satisfactory cardioid directional characteristic in the state that each of the capacitor elements has been assembled.

Therefore, the capacitor elements 10a, 10b are combined, after each of the capacitor elements has been adjusted such that an acoustic resistance of each capacitor element has a predetermined value.

However, no expected characteristics may be obtained after the capacitor elements have been combined. In this case the acoustic resistance should be re-adjusted. In the above-described example of the prior art, the acoustic resistance cannot be adjusted in the state that the both capacitor elements have been left combined so that the connecting ring should be removed and the acoustic resistance should be re-adjusted after each of the capacitor elements has been decomposed. However, there is no guarantee that the adjustment of the acoustic resistance is completed only once.

### SUMMARY OF THE INVENTION

It is an object of the present invention to provide a variable directional capacitor microphone in which two capacitor elements are combined. Each of the capacitor elements includes a vibrating plate and a fixed electrode, and an acoustic resistance can be adjusted in the state that the microphone has been assembled.

In order to achieve the object, the variable directional capacitor microphone includes a first and a second capacitor elements. In the first capacitor element, a first vibrating plate supporting member on which a first vibrating plate is fixed and strained, a first spacer ring, a first fixed electrode having through holes and a first insulating pedestal having a through hole in the center thereof are integratedly assembled in this order in a first case which is formed in a ring-shape. In the second capacitor element, a second vibrating plate supporting member on which a second vibrating plate is fixed and strained, a second spacer ring, a second fixed electrode having through holes and a second insulating pedestal having a through hole in the center thereof are integratedly assembled in this order in a second case which is formed in a ring-shape. The first and the second capacitor elements are combined through a connecting ring having female screw threads in the state that the first and the second insulating pedestals are faced back-to-back. The variable directional capacitor microphone is characterized in that an elastic acoustic resisting member is disposed between the first and the second insulating pedestals and the disposed position of the acoustic resisting member corresponds to the through hole bored in the center of each of the insulating pedestals.

An acoustic resistance of the acoustic resisting member can be adjusted with adjusting compress volume of the resisting member.

In this invention, it is preferable that an elastic gasket formed with rubber material or the like is disposed around the circumference of the acoustic resisting member installed between the first and the second insulating pedestals to prevent sound leakage through the acoustic resisting member.

In this case, form the viewpoint to cut the relation ship between compressed volume of the acoustic resisting member and that of the gasket and to increase degree of freedom of the compressed volume, it is preferable that a groove having a predetermined depth for receiving a part of each side of the acoustic resisting member is formed on one side of each through hole of the first and the second insulating pedestals.

Further, an aspect that each through hole of the first and the second insulating pedestals is covered with an acoustic resisting mesh member is included in this invention.

According to the invention, the compressed volume of the elastic acoustic resisting member is variable with the degree of fastening each of the insulating pedestals to the connecting ring so that the acoustic resistance can be adjusted. Therefore, the acoustic resistance can be adjusted to obtain a good directional characteristic in the state that each of the capacitor elements has been left combined (assembled) through the connecting ring.

### BRIEF DESCRIPTION OF THE DRAWINGS

FIG. 1 is a cross sectional view of a variable directional capacitor microphone which has been assembled embodying the present invention;

FIG. 2 is an exploded cross sectional view of the variable directional capacitor microphone embodying the present invention;

FIG. 3 is a cross sectional view of a variable directional capacitor microphone which has been assembled of a prior art; and

FIG. 4 is an exploded cross sectional view of the variable directional capacitor microphone of the prior art.

### DETAILED DESCRIPTION OF THE PREFERRED EMBODIMENTS

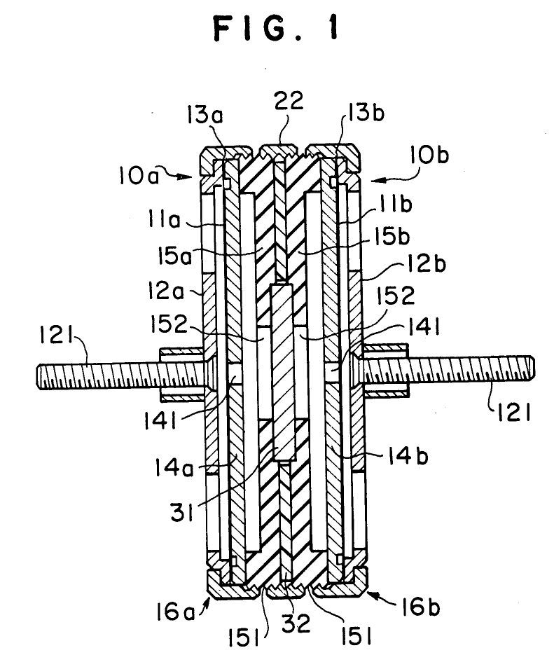

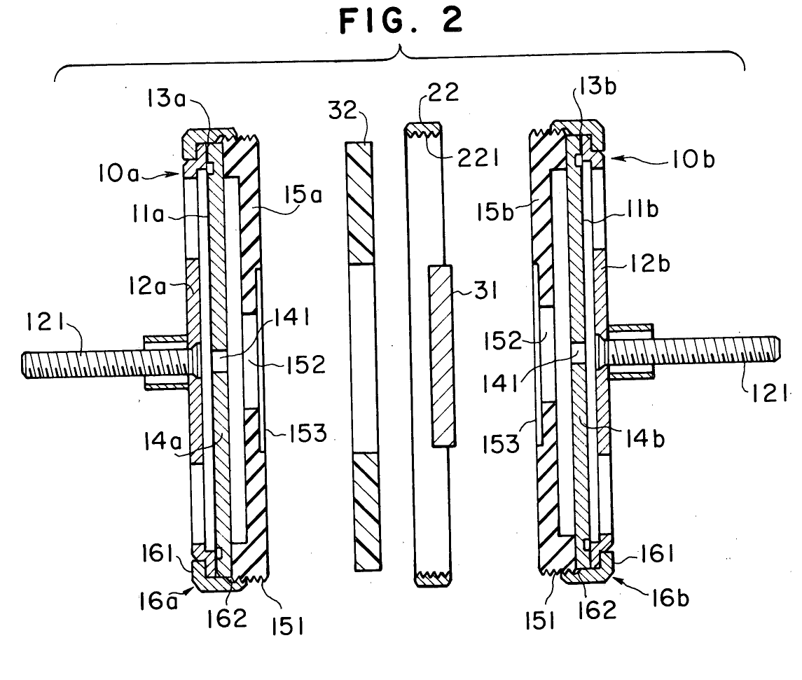

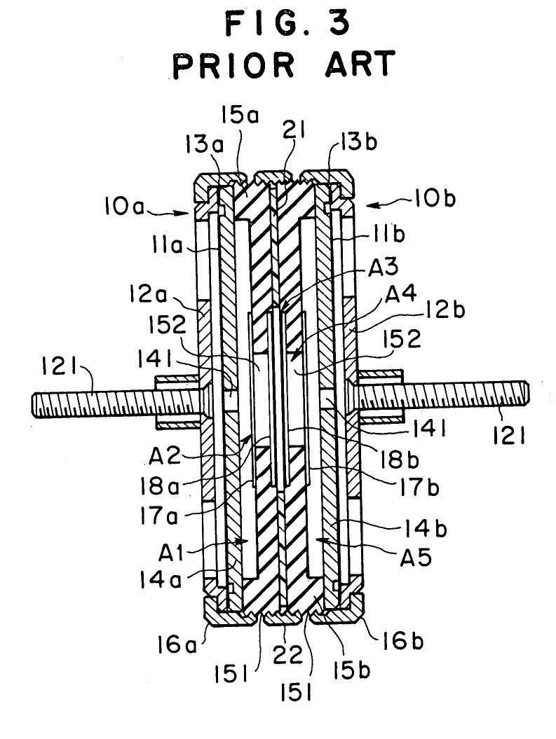

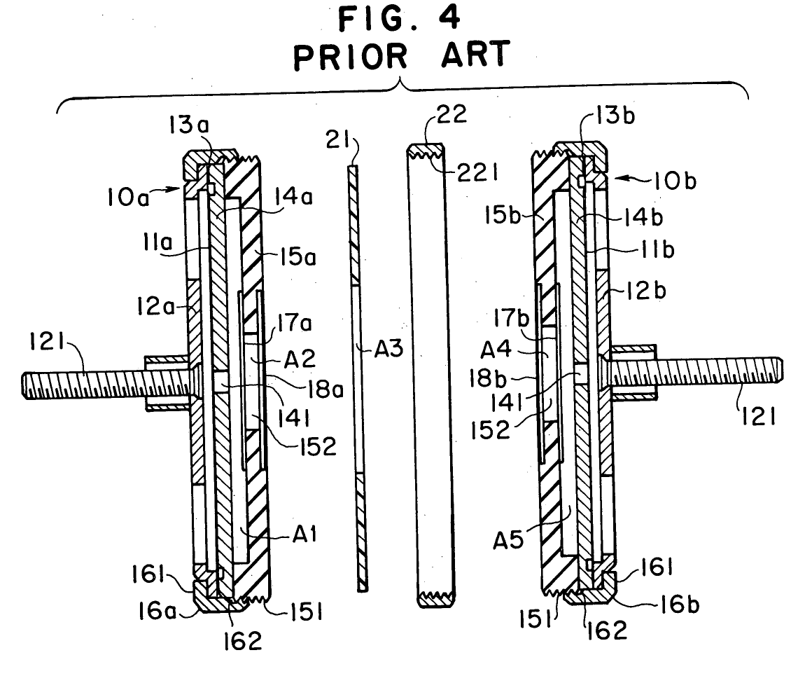

Referring to FIGS. 1 and 2, an embodiment of the present invention will be described. The invention is not restricted to this embodiment. FIG. 1 is a cross sectional view of a variable directional capacitor microphone which has been assembled embodying the present invention. FIG. 1 corresponds to FIG. 3 described before. FIG. 2 is an exploded cross sectional view of the variable directional capacitor corresponding to FIG. 4 described before. In the explanation of the embodiment, attached to the constituent elements which are the same or are deemed to be the same as that of a prior art are the same reference numerals and symbols as that of the prior art.

As the basic structure, the variable directional capacitor microphone of the invention includes a first and a second capacitor elements with the both elements combined through a connecting ring 22. Since the first and the second capacitor elements have the same structure as described above, hereinafter, the first capacitor element will be mainly described, however, the reference numerals and symbols of the constitutional elements relating to the second capacitor element will be written in parentheses.

The capacitor element 10a (10b) has a case 16a (16b) which is formed with electric insulating material. A vibrating plate supporting member 12a (12b), a spacer ring 13a (13b), a fixed electrode 14a (14b) and an insulating pedestal 15a (15b) are assembled in the case 16a (16b) in this order. A vibrating plate 11a (11b) is strained with a predetermined tension force and fixed on the vibrating plate supporting member 12a (12b).

The case 16a (16b) has an inner edge flange 161 latched with the circumference of the vibrating plate supporting member 12a (12b) and female screw threads 162 formed on the inner surface of the body of the case. The outer circumference of the insulating pedestal 15a (15b) has male screw threads 151 screwed with the female screw threads 162. Therefore, the vibrating plate 11a (11b) and the fixed electrode 14a (14b) are faced through the spacer ring 13a (13b) and are securely fixed by screwing the insulating pedestal 15a (15b) to the case 16a (16b).

An electrode rod 121 is extracted from the vibrating plate supporting member 12a (12b), respectively. FIG. 1 or 2 illustrates only one through hole 141, however, the fixed electrode 14a (14b) has a number of through holes 141. The insulating pedestal 15a (15b) is formed in a saucer-shape with the circumference of the pedestal protruding such that an air chamber having a predetermined air volume is formed between the insulating pedestal and the fixed electrode. The center of the bottom of the fixed electrode has a through hole 152.

The male screw threads 151, 151 of the insulating pedestal 15a, 15b are screwed to the female screw threads 221 of a connecting ring 22 with the insulating pedestals 15a and 15b facing back-to-back so that the first and the second capacitor elements 10a, 10b having the structure described above are combined. Further, an acoustic resisting member 31 which has a larger diameter than that of the through hole 152 is coaxially disposed between the insulating pedestals 15a and 15b. That is, each of the through holes 152 is covered with the acoustic resisting member 31.

The acoustic resisting member 31 is formed with a spongy elastic material which has continuous air bubbles. An acoustic resistance of the spongy material changes with a compressed volume thereof For example, product No. HR 50 of urethane sponge of Bridgestone Corporation is exemplified as the acoustic resisting member.

The acoustic resisting member 31 can be disposed in the whole area between the insulating pedestals 15a, 15b, however, it is preferable that an elastic gasket 32 formed with rubber material or the like is disposed around the circumference of the acoustic resisting material 31 in order to prevent a sound leakage through the acoustic resisting material 31.

According to this structure, the compressed volume of the acoustic resisting member 31 or the acoustic resistance is variable with the length of thread engagement of the insulating pedestal 15a, 15b with the connecting ring 22 so that the acoustic resistance between the vibrating plates 11a and 11b can be adjusted in the state that the first and the second capacitor elements 10a and 10b have been assembled.

In the case that the gasket 32 is disposed around the acoustic resisting member 31, when the gasket 32 is tightly pressed, the acoustic resisting member 31 is compressed until the resisting member 31 becomes the same thickness as that of the gasket because the gasket is harder than the acoustic resisting member so that an appropriate acoustic resistance may not be obtained.

In order to prevent the case described above and to increase degree of freedom of the compressed volume of the acoustic resisting member 31, as shown in FIG. 2, a groove 153 having a predetermined depth for receiving a part of each side of the acoustic resisting member 31 is formed on one side of each through hole 152 of the insulating pedestal 15a, 15b. The groove 153 is also used as positioning means of the acoustic resisting member 31.

An acoustic resisting member formed with nylon mesh or the like, which is not shown in FIG. 1 or 2, can be installed on the both sides (or one side) of the through hole 152. This aspect is included in this invention.

1. A variable directional capacitor microphone including a first and a second capacitor elements, in the first capacitor element a first vibrating plate supporting member, a first spacer ring, a first fixed electrode having through holes and a first insulating pedestal having a through hole in the center of the pedestal integratedly assembled in this order in a first case formed in a ring-shape, a first vibrating plate strained and fixed on the first vibrating plate supporting member, in the second capacitor element a second vibrating plate supporting member, a second spacer ring, a second fixed electrode having through holes and a second insulating pedestal having a through hole in the center of the pedestal integratedly assembled in this order in a second case formed in a ring-shape, a second vibrating plate strained and fixed on the second vibrating plate supporting member, the first and the second capacitor elements combined through a connecting ring having female screw threads with the first and the second insulating pedestals faced back-to-back, the variable directional capacitor microphone comprising:
an elastic acoustic resisting member disposed between the first and the second insulating pedestals; and
the acoustic resisting member disposed in the position corresponding to the through hole bored in the center of each of the insulating pedestals.

2. A variable directional capacitor microphone according to claim 1, wherein an elastic gasket is disposed around the circumference of the acoustic resisting member installed between the first and the second insulating pedestals.

3. A variable directional capacitor microphone according to claim 1, wherein a groove having a predetermined depth for receiving a part of each side of the acoustic resisting member is formed on one side of each through hole of the first and the second insulating pedestals.

4. A variable directional capacitor microphone according to claim 1, wherein each through hole of the first and the second insulating pedestals is covered with an acoustic resisting mesh member.

5. A variable directional capacitor microphone according to claim 2, wherein a groove having a predetermined depth for receiving a part of each side of the acoustic resisting member is formed on one side of each through hole of the first and the second insulating pedestals.

6. A variable directional capacitor microphone according to claim 2, wherein each through hole of the first and the second insulating pedestals is covered with an acoustic resisting mesh member.
